(19) United States
(12) Patent Application Publication
(10) Pub. No.: US 2013/0111047 A1
(43) Pub. Date: May 2, 2013

(54) SESSION TRANSFER

(71) Applicants: Gameelah Ghafoor, Dundee (GB); Richard Douglas Lawson, Dundee (GB); Colin Herkes, Fife (GB)

(72) Inventors: Gameelah Ghafoor, Dundee (GB); Richard Douglas Lawson, Dundee (GB); Colin Herkes, Fife (GB)

(73) Assignee: NCR CORPORATION, Duluth, GA (US)

(21) Appl. No.: 13/285,685

(22) Filed: Oct. 31, 2011

(51) Int. Cl. G06F 15/16

(52) U.S. Cl. 709/229

(57) ABSTRACT

A session transfer computer program is described. The program comprises: a credential management component arranged to store credentials used by a first device in a session; and a session transfer component arranged to send a request to a second device for transferring the session thereto.

### FIELD OF INVENTION

The present invention relates to session transfer. In particular, although not exclusively, the invention relates to transfer of a transmission control protocol (TCP) session from one internet protocol (IP) device to another IP device.

### BACKGROUND OF INVENTION

People typically have a plurality of devices that can connect to the Internet. For example, a person may have a cellular radiofrequency telephone (referred to herein as a “cellphone”), a laptop computer, an IP telephone, a tablet computer, and the like.

A person may start browsing the World Wide Web (hereinafter the “Web”) on one IP device (such as a laptop) and then may have to move to a new location, for example, to meet friends. It would be desirable if such a person could transfer the Web session to another device (such as a cellphone) without having to restart the session. Similarly, a person may be using a cellphone to have a conversation and a battery in the cellphone may be almost out of charge. It would be desirable to be able to transfer the call to another device without having to forward the call to another phone number.

### SUMMARY OF INVENTION

Accordingly, the invention generally provides methods, systems, apparatus, and software for transferring a session from one device to another without losing the state of the session.

In addition to the Summary of Invention provided above and the subject matter disclosed below in the Detailed Description, the following paragraphs of this section are intended to provide further basis for alternative claim language for possible use during prosecution of this application, if required. If this application is granted, some aspects may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there is provided a session transfer computer program comprising:
a credential management component arranged to store credentials used by a first device in a session; and
a session transfer component arranged to send a request to a second device for transferring the session thereto.

A session has been described as a semi-permanent interactive information interchange between computing devices.

The credential management component may store: an address associated with the first device; an address associated with a server communicating with the first device; security credentials provided by the first device to the server; a protocol being used to support the session, state information (for example, in the form of a cookie), and the like.

The session transfer computer program may be executed by the first device. The second device may also execute an instance of the session transfer computer program. Alternatively, the session transfer computer program may be executed on a router to which both the first and second devices are connected.

The address associated with the first device may comprise an internet protocol (IP) address.

The address associated with a server communicating with the first device may also comprise an IP address.

The security credentials may include login credentials, such as a username and passcode combination, a certificate, an IP address, and the like.

The protocol being used to support the session may comprise secure sockets layer, or the like.

The credential management component may also store a type and version of encryption used, and any other convenient information.

Where the session transfer computer program is executed on a router, each of the first and second devices may include a transfer request component operable to issue a transfer request to the router in response to a user of the device requesting a session transfer.

The second device may receive a list of available sessions for transfer from either the first device or the router. The list of available sessions for transfer may be provided in response to a request from the second device for this list.

According to a second aspect there is provided session transfer apparatus comprising:
a first device operable to initiate a session with a remote server;
a second device also operable to initiate a session with a remote server; and
a router coupled to both the first and second devices, the apparatus further comprising: a session transfer computer program comprising:
a credential management component arranged to store credentials used by the first device during a session; and
a session transfer component arranged to send a request to the second device for transferring the session thereto.

The session transfer computer program may be stored on the first device and/or the second device. Alternatively, the session transfer computer program may be stored on the router.

According to a third aspect there is provided a method of transferring a session from a first device that initiated the session to a second device, the method comprising:
storing credentials used by the first device during a session;
sending a request to transfer the session to the second device;
providing the stored credentials relating to the session initiated by the first device to the second device; and
transferring the session to the second device.

The second device may accept or reject the request to transfer the session from the first device.

It should now be appreciated that these aspects have the advantage of allowing a user to transfer a session seamlessly from one device to another without losing the state of their application and without having to login again. This may be advantageous if the user wants to use a different (enhanced, or, alternatively, more private) user interface, if the battery is nearly discharged on the current device, or if the current device is not portable and the user desires to move to a new physical location.

These and other aspects will be apparent from the following specific description, given by way of example, with reference to the accompanying drawings.

### BRIEF DESCRIPTION OF THE DRAWINGS

FIG. 1 is a simplified block diagram illustrating a system comprising three networked devices according to one embodiment of the present invention;

FIG. 2 is a flowchart illustrating steps performed by one (the first) device of FIG. 1 to initiate a session with another (the third) device of FIG. 1;

FIG. 3 is a flowchart illustrating steps performed by the first device to transfer the initiated session to another of the devices (the second device) of FIG. 1;

FIG. 4 is a flowchart illustrating steps performed by the second device of FIG. 1 in receiving a session from the first device of FIG. 1 and continuing the session with the third device of FIG. 1; and

FIG. 5 is a simplified block diagram illustrating an alternative session transfer system comprising three networked devices according to another embodiment of the present invention.

### DETAILED DESCRIPTION

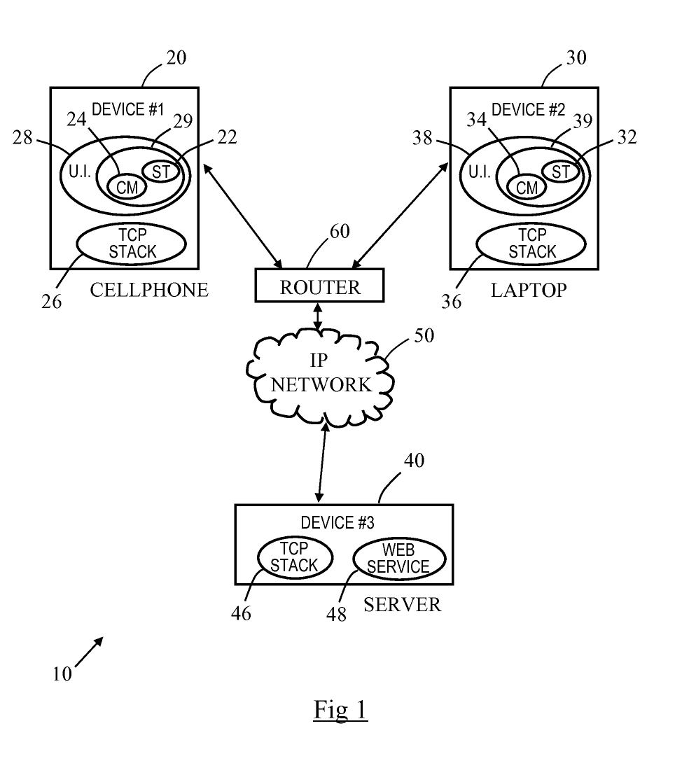

Reference is first made to FIG. 1, which is a simplified block diagram of an internet protocol (IP) network system 10.

The IP network system 10 comprises a first device 20 in the form of a portable cellular radiofrequency telephone (referred to as either a cellphone or a mobile phone). In addition to the standard cellphone features (such as those commonly provided on a smartphone), the cellphone 20 comprises additional software components, including: a session transfer (ST) component 22 and a credential management (CM) component 24 communicating with conventional transmission control protocol (TCP) software stack 26.

The ST component 22, the CM component 24, and the TCP stack 26 are all software components executing on a processor (not shown) in the cellphone 20. The cellphone 20 also includes a user interface application 28 that presents information to a user and receives inputs from the user. The cellphone 20 is of the type of cellphone referred to as a smartphone, and can access the Internet and the Web using the TCP stack 26 and the user interface application 28 (which includes a conventional microbrowser component 29). In this embodiment, the ST component 22 and CM component 24 are provided as plug-in components for the microbrowser 29.

The IP network system 10 further comprises a second device 30 in the form of a laptop computer. In a similar manner to the cellphone 20, the computer 30 includes a session transfer (ST) component 32 and a credential management (CM) component 34 communicating with a conventional transmission control protocol (TCP) stack 36. The computer 30 also includes standard features commonly provided on a computer (such as a display, a keypad, a processor, a Web browser, and the like) but these are well known so they are not shown in detail herein. The computer 30 also includes a user interface application 38 that presents information to a user and receives inputs from the user. The user interface application 38 includes a conventional Web browser 39. Again, the ST component 32 and the CM component 34 are provided as plug-in components for the Web browser 39.

The cellphone 20 and computer 30 are substantially co-located. In other words, they are quite close to each other. In this embodiment, both of the cellphone 20 and computer 30 are owned by the same person, and are located in that person's house.

The IP network system 10 further comprises a third device 40 (remote from the cellphone 20 and computer 30). In this embodiment, the third device 40 comprises a Web server. The Web server 40 includes a conventional TCP stack 46 and a Web service 48.

The cellphone 20, the computer 30, and the Web server 40 are all mutually connectable via the Internet 50. Any device (such as the cellphone 20 and the computer 30) that is connected to the Internet 50 can access the Web service 48.

The cellphone 20 and the computer 30 are located within the person's house and are connected to the Internet 50 via a router 60. In this embodiment, the router 60 is a conventional, commercially available router, without any hardware or software modifications.

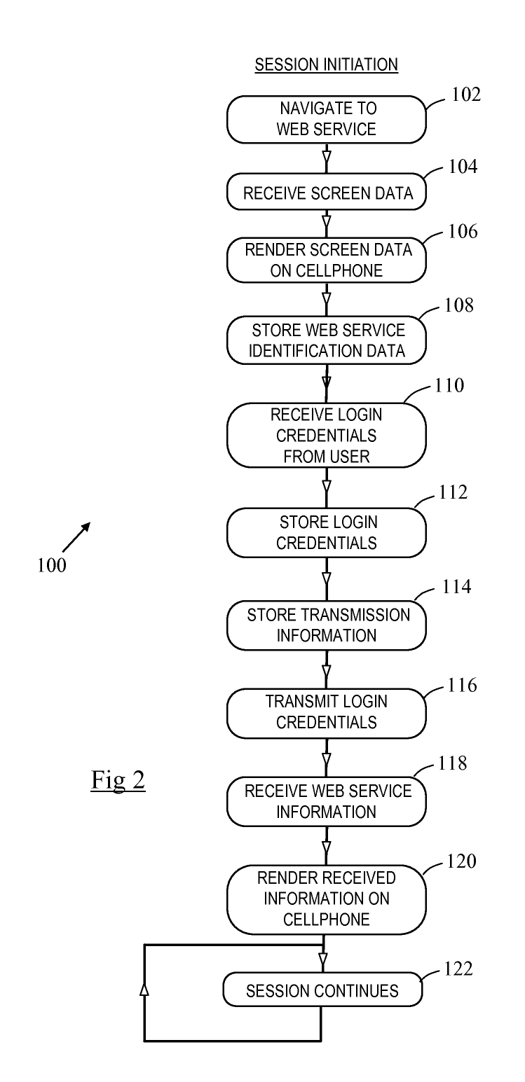

Operation of the cellphone 20 to initiate a session with the Web service 48 will now be described with reference to FIG. 2, which illustrates a session initiation flowchart 100.

Initially, the owner of the cellphone 20 (the cellphone user) desires to access the Web service 48 to obtain information provided by that Web service 48. The cellphone user launches the microbrowser 29 on the user interface application 28 and navigates to the Web service 48 (step 102).

The Web service 48 provides the microbrowser 29 with screen information for a login screen, including login data entry fields. The cellphone 20 receives this screen information (step 104) and renders it using the cellphone's microbrowser 29 (step 106).

The cellphone 20 stores Web service identification data in the credential management (CM) component 24 (step 108). The Web service identification data includes information such as: the IP address of the Web server 40, the DNS name of the Web server 40, the URL for the Web service 48, the port number used by the Web service 48, and the like. The reason for storing this Web service identification data is to be able to provide sufficient information about the Web service 48 to another device in the event that the session between the cellphone 20 and the Web service 48 is to be transferred to that other device.

In addition to the Web service identification data, the cellphone 20 also stores additional session information (such as the current state of the session) in a state cookie. The state cookie is updated with current state information as the cellphone user receives and enters data via the microbrowser 29.

The cellphone user enters his/her login credentials on the login screen, which the user interface application 28 receives (step 110).

Optionally, the cellphone 20 may store the login credentials in the CM component 24 (step 112) in encrypted (or other secure) format.

The cellphone 20 also stores transmission-related information in the CM component 24 (step 114). This transmission information includes the transmission protocols used (such as IPv6), the encryption used (such as secure sockets layer (SSL)), and any other information relevant to how data is communicated.

The cellphone 20 then transmits the entered login credentials (in secure format) to the Web service 48 (step 116).

The Web service 48 authenticates the received login credentials and (if the login credentials are correct) transmits information to the cellphone 20 (which may be the cellphone user's home page on the Web service 48). The cellphone 20 receives this information (step 118) and renders it on the microbrowser 29 to the cellphone user (step 120).

At this point, there is a TCP session between the cellphone's microbrowser 29 and the Web server's Web service 48. This session continues for as long as desired by the cellphone user (step 122). The CM component 24 contains (or has access to, for example, via the state cookie) all the relevant information about this TCP session.

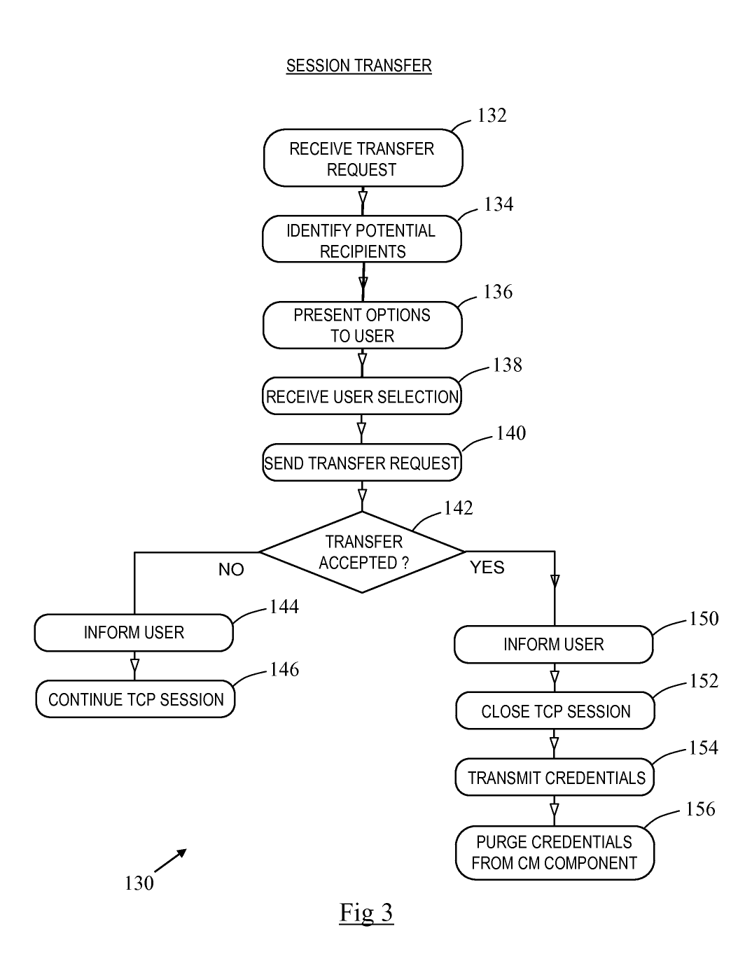

The cellphone user may desire to re-create this TCP session on another IP device, such as the computer 30. One reason for this might be that the computer 30 has a larger keyboard and a larger display that makes data entry and reading of information easier. Another reason might be that the battery in the cellphone 20 may be at a low charge level. Whatever the reason, the cellphone user can continue the TCP session on the computer 30, as will now be described with reference to FIG. 3, which is a flowchart 130 illustrating the steps involved in such a transfer.

To re-create the TCP session, the cellphone user selects a session transfer option presented by the user interface application 28. This selection is received by the cellphone 20 (step 132).

The cellphone 20 then identifies any devices on which the TCP session can be re-created (step 134). In this example, this step involves two sub-steps.

The first sub-step is for the session transfer (ST) component 22 to access a pre-populated list of trusted devices. The list of trusted devices was populated by the cellphone user and is stored in the cellphone 20. This list of trusted devices includes a unique identification for each device in the list. The unique identification may be a hardware identifier (such as a MAC address), an IP address, a telephone number, or the like. Where an IP address of a device changes (for example, because it was dynamically assigned), the ST component 22 may automatically update the device's unique identifier when a new IP address is allocated to that device. In this example, the cellphone user has added the IP address of the computer 30 to the trusted device list stored in the ST component 22.

The second sub-step is for the ST component 22 to contact those devices on the populated list to ascertain which devices are currently present (that is, switched on and connected to the Internet 50). This may be implemented by the ST component 22 pinging the IP address of the devices on the populated list, or in any other convenient manner.

The cellphone 20 then presents to the cellphone user a list of the devices identified as being trusted and available for receiving the transfer request (step 136).

The cellphone user selects one of these devices from the list, which the user interface application 28 detects (step 138).

The cellphone 20 then sends a transfer request to the selected device (in this example, the laptop computer 30) (step 140). The transfer request is issued by the ST component 22 and is sent to the corresponding ST component 32 in the laptop computer 30. Although sometimes referred to herein as a “transfer”, in essence, a new TCP session is created that includes all of the information from the previous TCP session, and the old TCP session is ended. This appears to a user to be a transfer, although in effect it is merely one session closing and a new session opening (but the new session has the characteristics of the previous session).

The ST component 32 in the laptop computer 30 receives this request and presents it on a display (not shown) using the user interface application 38. The laptop computer user (in this example, it will probably be the cellphone user because the cellphone user wants to continue the session on the computer 30) is then given the option of accepting or rejecting the session transfer request. In this example, the laptop computer user accepts the transfer request, which the ST component 32 communicates to the cellphone 20.

The cellphone 20 receives and evaluates this response (step 142).

If the computer user does not want to receive the TCP session, then the cellphone user interface application 28 informs the cellphone user (step 144), and continues with the TCP session as normal (step 146).

However, if the computer user does want to receive the TCP session, then the cellphone user interface application 28 informs the cellphone user accordingly (step 150).

The ST component 22 then initiates transfer of the TCP session by relinquishing its existing application session to close the TCP session (step 152). This is implemented by the TCP stack issuing a close command.

The ST component 22 then transmits (in a secure manner) the information stored in the credential management (CM) component 24 relating to the TCP session that has just been closed (step 154).

The ST component 22 then purges the session information from the CM component 24 (step 156).

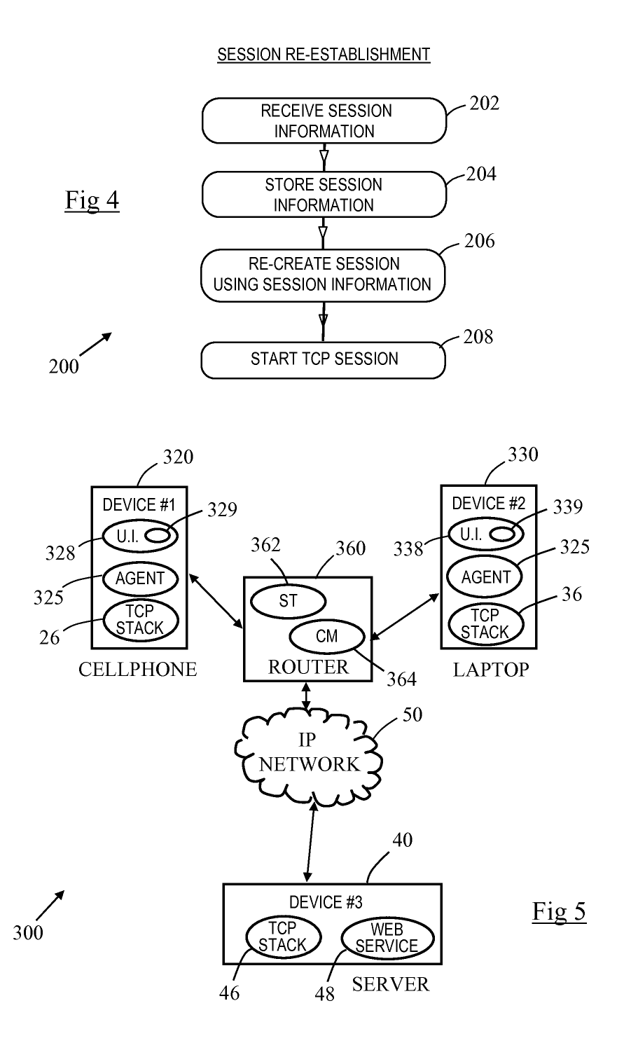

On receipt of the session information, the laptop computer 30 re-creates the session with the Web service 48, as illustrated in flowchart 200 in FIG. 4.

Initially, the ST component 32 in the laptop computer 30 receives the session information from the ST component 22 in the cellphone 20 (step 202).

The ST component 32 then populates the CM component 24 with the received session information (step 204).

The ST component 32 then uses this received session information to re-create the session that the ST component 22 relinquished (step 206). This is implemented using the open command within the TCP/IP protocol.

The laptop user can then continue at the same point in the session that was initiated by the cellphone user (step 208), on a new session on the laptop computer 30.

An alternative embodiment will now be described with reference to FIG. 5, which is a simplified block diagram illustrating an alternative session transfer system 300 comprising three networked devices according to another embodiment of the present invention.

System 300 comprises a first device (a cellphone) 320, a second device (a laptop computer) 330, and a modified router 360.

The cellphone 320 comprises: a transfer request agent 325 (also referred to as a transfer request component), a conventional TCP stack 26, and a user interface application 328 (similar to user interface application 28) including a microbrowser 329.

Similarly, the laptop computer 30 comprises: a transfer request agent 335, a conventional TCP stack 36, and a user interface application 338 (similar to user interface application 38) including a microbrowser 339.

In system 300, neither the first nor second device (the cellphone 320 and laptop computer 330 respectively) includes a session transfer or credential management component. Instead, the router 360 is modified to include a session transfer component 362 and a credential management component 364.

The Web server 40 is identical to the corresponding Web service in the system 10.

In this embodiment, the router 360 maintains a list of the available devices that could be used to receive a TCP session. If a user of a device connected to the router 360 (for example, the cellphone 320) desires to transfer a session to another device connected to the router 360 (for example, the laptop computer 330), then that user can make a transfer request via the agent 325. The agent 325 informs the router 360 of the request, and the router 360 provides the agent 325 with a list of available devices to which the TCP session can be transferred. This list is presented to the user by the agent 325 via the user interface application 328. The user then makes a selection of which device the session is to be transferred to, and the agent 325 informs the router 360 of this selection.

The router 360 then informs the agent 335 on the selected device of the request to transfer the TCP session. The agent 335 presents this request to the user of the selected device and receives a response from the user. The agent 335 then conveys this response to the router 360.

If the selected device (in this example the laptop computer 330) is willing to receive the TCP session, then the router 360 handles transfer of the session to the selected device using the session transfer component 362 and the credential management component 364, in a similar manner to that described with reference to the first embodiment.

Various modifications may be made to the above described embodiments within the scope of the invention, for example, in other embodiments the devices listed may differ from those described. Any convenient IP device that is coupled to the Internet may be used.

In variants of the first embodiment, the first device (the cellphone 20 in the above embodiment) may relinquish its lower level identifiers (such as IP address and MAC address), and the second device (the laptop computer 30 in the above embodiment) may use the lower level identifiers (IP address and MAC address) relinquished by the first device to re-establish the TCP session. This may be implemented by the second device requesting these lower level identifiers using the ARP/RARP and DNS protocols.

In other embodiments, the session transfer component may not be pre-populated with trusted devices. Instead, devices may publish their availability for receiving a session. Such devices may include certificates of authenticity that are examined by the session transfer component to ensure that the device can be trusted.

In other embodiments, the session transfer component and the credential management component may be combined, or may be integrated into a bespoke TCP software stack.

It should now be appreciated that these embodiments allow a user to continue a TCP transaction or an online interaction between devices without having to re-initiate either the security credentials or the connection parameters.

The steps of the methods described herein may be carried out in any suitable order, or simultaneously where appropriate.

The terms “comprising”, “including”, “incorporating”, and “having” are used herein to recite an open-ended list of one or more elements or steps, not a closed list. When such terms are used, those elements or steps recited in the list are not exclusive of other elements or steps that may be added to the list.

Unless otherwise indicated by the context, the terms “a” and “an” are used herein to denote at least one of the elements, integers, steps, features, operations, or components mentioned thereafter, but do not exclude additional elements, integers, steps, features, operations, or components.

The presence of broadening words and phrases such as “one or more,” “at least,” “but not limited to” or other similar phrases in some instances does not mean, and should not be construed as meaning, that the narrower case is intended or required in instances where such broadening phrases are not used.

What is claimed is:

1. A session transfer computer program comprising:
a credential management component arranged to store credentials used by a first device in a session; and
a session transfer component arranged to send a request to a second device for transferring the session thereto.

2. A session transfer computer program according to claim 1, wherein the credential management component stores at least one of: an address associated with the first device; an address associated with a server communicating with the first device; security credentials provided by the first device to the server; and a protocol being used to support the session.

3. A session transfer computer program according to claim 1, wherein the session transfer computer program is executed by the first device.

4. A session transfer computer program according to claim 3, wherein the second device also executes an instance of the session transfer computer program.

5. A session transfer computer program according to claim 1, wherein the session transfer computer program is executed on a router to which both the first and second devices are connected.

6. A session transfer computer program according to claim 1, wherein the address associated with the first device comprises an internet protocol (IP) address.

7. A session transfer computer program according to claim 1, wherein the security credentials include at least one of: login credentials, a certificate, and an IP address.

8. A session transfer computer program according to claim 1, wherein the credential management component stores a type and version of encryption used.

9. Session transfer apparatus comprising:
a first device operable to initiate a session with a remote server;
a second device also operable to initiate a session with a remote server; and
a router coupled to both the first and second devices, the apparatus further comprising: a session transfer computer program comprising:
a credential management component arranged to store credentials used by the first device during a session; and
a session transfer component arranged to send a request to the second device for transferring the session thereto.

10. Session transfer apparatus according to claim 9, wherein the session transfer computer program is stored on the first device.

11. Session transfer apparatus according to claim 9, wherein the session transfer computer program is stored on the router.

12. A method of transferring a session from a first device that initiated the session to a second device, the method comprising:
storing credentials used by the first device during a session;
sending a request to transfer the session to the second device;
providing the stored credentials relating to the session initiated by the first device to the second device; and
transferring the session to the second device.

13. A method according to claim 12, wherein the second device accepts or rejects the request to transfer the session from the first device.

14. A method according to claim 12, wherein the step of storing credentials used by the first device during a session is performed by a router.
